(19) United States
(12) Patent Application Publication
(10) Pub. No.: US 2015/0321935 A1
(43) Pub. Date: Nov. 12, 2015

(54) METHOD OF OXIDISING PRODUCTION WATER

(71) Applicant: TOTAL SA, Courbevoie (FR)

(72) Inventors: Nicolas LESAGE, Billere (FR); Pierre PEDENAUD, Lescar (FR); Matthieu JACOB, Cescau (FR)

(21) Appl. No.: 14/652,020

(22) PCT Filed: Dec. 10, 2013
(86) PCT No.: PCT/FR2013/053016

§ 371 Date: Jun. 12, 2015

(30) Foreign Application Priority Data
Dec. 12, 2012 (FR) 1261944

(51) Int. Cl. C02F 9/00

(52) U.S. Cl. CPC C02F 9/00; C02F 1/281

(57) ABSTRACT

The invention relates to a process for removing pollution from production water, comprising the steps of introducing the production water and ozone into a reactor containing zeolites, subjecting the production water in the reactor to irradiation by UV light, and separating the production water from the zeolites, so as to obtain production water from which pollution has been removed. The invention also relates to a device for removing pollution from production water.

### RELATED APPLICATIONS

The present application is a National Phase entry of PCT Application No. PCT/FR2013/053016, filed Dec. 10, 2013, which claims priority from French Patent Application No. 1261944, filed Dec. 12, 2012, said applications being hereby incorporated by reference herein in their entirety.

### FIELD OF THE INVENTION

The present invention falls within the general context of water management in the extraction of hydrocarbons. More specifically, the present invention relates to a process for removing pollution from production water, and also to the corresponding device for removing pollution.

### BACKGROUND OF THE INVENTION

During the production of hydrocarbons by drilling, the stream extracted from the underground formation is typically a mixture of hydrocarbons, water and solid particles. This stream, called production stream, is generally treated by settling out and then, inter alia, by hydrocycloning or by means of a flotation unit, so as to separate it into at least one exploitable hydrocarbon-based fraction and one aqueous fraction called production water.

Alternatively, some hydrocarbons can be produced by mining extraction techniques. Tar sands can be extracted from open-air quarries, and the bitumen fraction is separated from the sand by washing processes. At the end of the washing process, a solid phase consisting essentially of sand, a bitumen phase and an aqueous phase comprising essentially water, the additives used for the washing and hydrocarbon residues, essentially bitumens, are obtained.

In the present application, the term “production water” refers to the aqueous fraction or phase obtained at the end of a hydrocarbon extraction process, whether it is an extraction process by drilling or a mining extraction process.

In any event, production water is a by-product of hydrocarbon extraction, the management of which can be problematic. This is because production water contains essentially water, but also numerous compounds which pollute the environment and which cannot be discharged without prior treatments. Production water can in particular contain:
dispersed hydrocarbons, i.e. hydrocarbon particles in suspension, the diameter of which can range from a few nanometers to a few micrometers depending on the treatments used,
dissolved or dispersed organic compounds, in particular hydrocarbons and hydrocarbon derivatives, typically naphthenic acids when the production water is obtained during the production of hydrocarbons by mining extraction,
microorganisms,
dissolved salts,
heavy metals,
dissolved gases.

The concentration of dispersed hydrocarbons and of particles in suspension in production water is typically between 0 and 500 mg/l according to the extraction site.

Regulations impose discharge standards for production waters. Currently, the standards relating to offshore discharges are less strict than those relating to onshore discharges. Typically, the offshore discharge standards relate only to dispersed hydrocarbons. The offshore discharge threshold generally authorized is 30 mg/l of dispersed hydrocarbons (see, for example, the OSPAR recommendation 2001/1 for the North-East Atlantic zone).

However, new standards should in the future come into force and also impose limitations on other polluting components, and in particular on dissolved or dispersed organic compounds.

It is therefore desirable to have a process which makes it possible to reduce the amount of organic compounds discharged in production water. Advantageously, this process should make it possible to treat all types of organic compounds sufficiently effectively to achieve acceptable concentrations before discharge into the environment.

Physical, chemical and/or biological processes which enable thorough treatments already exist. However, the existing processes have the drawback of being bulky. Indeed, in order to be able to thoroughly treat all types of organic compounds, it is generally necessary either to string together several successive unitary treatment operations or to prolong the contacting time of the water treated in the treatment device, which amounts to increasing the contacting surface area for a given flow rate.

In point of fact, it would be preferable to have a compact process, in particular in order to be able to implement it on an offshore platform.

Moreover, European patent application EP 0 625 482 describes a process and a facility for purifying an aqueous effluent containing an organic matter. However, said document does not relate to the specific treatment of production water.

It would therefore be desirable to have a process which makes it possible to reduce the amount of organic compounds in production water and which has the following advantages, that are a priori incompatible:
allows the significant and non-selective reduction of all types of organic compounds, and
has a small space requirement.

### SUMMARY OF THE INVENTION

An object of the invention is a process for removing pollution from production water, comprising the steps consisting in:
introducing said production water and ozone into a reactor containing zeolites,
subjecting the production water in the reactor to irradiation by UV light, and
separating the production water from the zeolites by virtue of a separating means, so as to obtain production water from which pollution has been removed.

It is a question, in the present invention, of a process for removing pollution from production water through the combined and simultaneous use of ozone, of UV light and of zeolites.

Another object of the invention is a device for removing pollution from production water, comprising:
a reactor containing zeolites, which has one or more inlet openings for introducing said production water and ozone, and at least one outlet opening;
one or more UV light source(s) arranged so as to irradiate the production water in the reactor;
a means for separating the production water from the zeolites, and enabling the recovery of zeolite-free production water from which pollution has been removed.

### BRIEF DESCRIPTION OF THE DRAWINGS

FIG. 1 represents an embodiment of a device for removing pollution from production water according to the invention.

FIG. 2 represents the change in TOC (Total Organic Carbon) (in milligrams of carbon per litre of water) as a function of time (in minutes) for various treatments described in Example 1.

FIG. 3 represents the reduction in TOC (as percent) as a function of residence time of the production water (in minutes) for various treatments described in Example 4.

### DETAILED DESCRIPTION OF THE DRAWINGS

It is specified that, throughout this description, the expression “between . . . and . . . ” should be understood as including the limits mentioned.

In the present invention, the production water can be obtained at the end of a process for extracting hydrocarbons by drilling or a mining extraction process.

In the case of an extraction process by drilling, the term “production stream” refers to the stream from an underground formation containing hydrocarbons. The production stream is a mixture of hydrocarbons, of water and, optionally, of solid particles and of gases. This production stream is separated into several fractions in a separation unit which can typically be a decanter, a hydrocyclone, a flotation unit, a membrane filtration unit or any other appropriate treatment unit. At least one hydrocarbon-based fraction is recovered in a hydrocarbon collection line and an aqueous fraction is withdrawn. The term “production water” refers to the aqueous fraction obtained after separation of the production stream.

In the case of a mining extraction process, tar sands, which must be treated by means of washing processes, can be extracted from quarries. At the end of the washing process, a solid phase consisting essentially of sand, a bituminous phase and an aqueous phase comprising essentially water, the additives used for the washing and hydrocarbon residues, essentially bitumens, are obtained. The aqueous phase obtained after washing is referred to as “production water”.

The production water can contain impurities, for example:
dispersed hydrocarbons, i.e. hydrocarbon particles in suspension, the diameter of which can range from a few nanometers to a few micrometers depending on the treatments used,
dissolved or dispersed organic compounds, in particular hydrocarbons and hydrocarbon derivatives, typically naphthenic acids,
microorganisms,
dissolved salts,
heavy metals,
dissolved gases,
chemical additives which may have been added during the hydrocarbon extraction process.

The concentration of dispersed hydrocarbons and of particles in suspension in the production water is typically between 0 and 500 mg/l according to the extraction site.

Among the dissolved or dispersed organic compounds present in the production water, some are considered to be polluting since they are capable of damaging human health or the quality of aquatic ecosystems.

In the present description, the terms “removal of pollution” and “removing pollution” denote the action which makes it possible to reduce the amount of compounds considered to be polluting in a stream containing them.

Among the polluting compounds, mention may in particular be made of polycyclic aromatic hydrocarbons, BTEXs, phenolic compounds, naphthenic acids and acetic acid.

In the present description, the term “polycyclic aromatic hydrocarbons”, or PAHs, denotes hydrocarbon-based compounds comprising at least two fused aromatic rings. Among the polycyclic aromatic hydrocarbons, mention may in particular be made of naphthalene and pyrene.

In the present description, the term “BTEXs” denotes compounds chosen from benzene, toluene, ethylbenzene, ortho-xylene, meta-xylene, para-xylene and mixtures thereof.

In the present description, the term “phenolic compounds” denotes hydrocarbon-based compounds comprising at least one benzene ring substituted at least once with a hydroxyl function. Among the phenolic compounds, mention may in particular be made of phenol.

In the present description, the term “naphthenic acids” denotes hydrocarbon-based compounds and mixtures of hydrocarbon-based compounds comprising at least one saturated ring comprising 5 or 6 carbons, said ring being substituted at least once with a carboxylic acid function. The naphthenic acids generally have a molecular weight of between 180 and 350.

According to one embodiment of the present invention, the production water from which pollution is to be removed in the process which is the object of the invention contains polluting compounds. In particular, the production water may contain polycyclic aromatic hydrocarbons,

BTEXs, phenolic compounds, naphthenic acids, acetic acid, or a mixture of these compounds. The production water may contain:
at least 0.1 mg/l, preferably at least 1 mg/l, of polycyclic aromatic hydrocarbons, and/or
at least 0.5 mg/l, preferably at least 1 mg/l, of BTEXs, and/or
at least 0.5 mg/l, preferably at least 1 mg/l, of phenolic compounds, and/or
at least 0.1 mg/l, preferably at least 1 mg/l, of naphthenic acids, and/or
at least 0.1 mg/l, preferably at least 1 mg/l, of acetic acid.

Preferably, the production water introduced into the reactor has a concentration of suspended matter of less than or equal to 50 mg/l, preferably less than or equal to 10 mg/l, and even more preferably of between 0 mg/l and 5 mg/l. The measurement of the content of suspended matter is typically carried out according to ISO standard 11923:1997.

In the present invention, the expression “suspended matter”, or as abbreviation “SM”, denotes solid particles in suspension having a size greater than 0.45 μm (micrometers).

The process according to the present invention may also comprise a preliminary step consisting in reducing the SM concentration of the production water to a concentration less than or equal to 50 mg/l, preferably less than or equal to 10 mg/l, and even more preferably less than or equal to 5 mg/l. This step can be carried out by dilution, by filtration or by centrifugation. Preferably, the process according to the present invention also comprises a preliminary step consisting in removing the suspended matter present in the production water before introducing said production water into the reactor, preferably by centrifugation.

The production water introduced into the reactor preferably has a temperature of between 5° C. and 60° C., more preferably between 10° C. and 35° C., and even more preferably between 10° C. and 20° C. This temperature can optionally be kept constant throughout the treatment of the production water in the reactor using a temperature-maintaining means, such as those known to those skilled in the art, for example using a heat exchanger.

In addition, the production water introduced into the reactor preferably has a pH of between 6 and 10, more preferably between 7 and 10, and even more preferably between 7 and 9. The pH value can optionally be adjusted using a buffer.

In the process which is the object of the invention, the production water and ozone are introduced into a reactor containing zeolites.

The reactor can be fed with the production water continuously or sequentially, continuously being preferred. The reactor can be in the form of a column placed vertically. The production water is preferably introduced into the reactor via the bottom. The injection can be carried out at one point or at a multitude of points in the reactor.

The ozone (O₃) introduced into the reactor may be in pure gaseous form, in gaseous form as a mixture with other gases, in particular as a mixture with oxygen, or in a form dissolved in water. The ozone can be generated, by means of an ozone generator, from oxygen. An ozone generator generally produces a gaseous mixture of oxygen (O₂) and ozone (O₃).

The ozone can be brought into contact with the production water in the reactor or outside the reactor. According to a first embodiment, the ozone, and preferably the gaseous mixture of oxygen (O₂) and ozone (O₃), is introduced into the reactor, preferably by the bottom of the reactor, via an injection route different than that of the production water. According to a second embodiment, the ozone, and preferably the gaseous mixture of oxygen (O₂) and ozone (O₃), is firstly dissolved in all or part of the production water from which pollution is to be removed, before the production water/ozone mixture is introduced into the reactor.

The flow rates of the production water and of the ozone introduced into the reactor depend on the proportions of the reactor. However, the ratio (production water stream/ozone stream) can preferably be between 0.01 and 11, and more preferably between 0.02 and 0.5 and even more preferably between 0.03 and 0.2. If the ozone is introduced into the reactor in excess, the excess ozone can be extracted from the reactor so as to be destroyed and/or to be partially or totally reinjected into the reactor.

The reactor into which the production water and the ozone are introduced contains zeolites.

Zeolites are well-known porous, crystalline aluminosilicate compounds. The composition of the zeolites is very variable and adheres to the following backbone: Naₓ₁Caₓ₂Mgₓ₃Baₓ₄Kₓ₅ [Alₓ₆Siₓ₇Oₓ₈]. x9 H₂O, where X1 to X9 represent positive or zero integers.

The Si/Al ratio has an impact on the hydrophilic/hydrophobic nature of the zeolite. In the present invention, it is considered that
a hydrophilic zeolite is a zeolite for which the x7/x6 ratio is less than or equal to 50, more preferably less than or equal to 10;
a hydrophobic zeolite is a zeolite for which the x7/x6 ratio is greater than or equal to 100, more preferably greater than or equal to 200.

According to a first embodiment of the present invention, the zeolites present in the reactor are hydrophilic zeolites.

According to a second embodiment of the present invention, the zeolites present in the reactor are hydrophobic zeolites.

According to a third embodiment of the present invention, the zeolites present in the reactor are a mixture of hydrophilic zeolites and hydrophobic zeolites. According to this embodiment, the weight ratio of the hydrophilic zeolites to the hydrophobic zeolites is preferably between 1/99 and 99/1, more preferably between 20/80 and 80/20, and even more preferably between 40/60 and 60/40.

The zeolites contained in the reactor may preferably be in powder form and may be characterized by a particle size profile and a specific surface area. Preferably, the zeolites of the present invention have a specific surface area greater than or equal to 200 m²/g, and more preferably greater than 400 m²/g.

Zeolites are currently commercially available and may be suitable for the present application. As hydrophilic and hydrophobic zeolites, mention may be made, for example, of the zeolites provided by the company Zeochem®.

The weight of zeolites present in the reactor depends on the proportions of the reactor. The weight of zeolites, given in grams per liter of reactor, is preferably between 0.5 g/l and 10 g/l, more preferably between 1 g/l and 8 g/l and even more preferably between 3 g/l and 6 g/l.

According to the process which is the object of the present invention, the production water in the reactor is subjected to irradiation by UV light.

For the purposes of the present invention, the term “UV light” denotes light radiation of which the wavelength is between 10 nm and 400 nm. Preferably, the wavelength of the UV light used in the process is between 50 nm and 350 nm, and more preferably between 150 nm and 300 nm.

The UV light may be generated by means of one or more UV lamps. In the present description, the term “UV lamp” denotes a lamp which makes it possible to produce UV light having the desired wavelength. Numerous UV lamps are commercially available. The UV lamp may be arranged in any way in the reactor, insofar as the UV light produced irradiates the production water in the reactor. Preferably, the UV lamp is arranged in such a way that a maximum surface area of production water is irradiated. According to one embodiment, the reactor is column-shaped and the UV lamp is a single cylindrically shaped lamp, and said lamp is placed at the center of the reactor. According to another embodiment the reactor may be placed horizontally, and several UV lamps are placed at several sites inside the reactor. Baffles can be fitted inside the reactor in order to optimize the circulation of the streams. Whatever the arrangement of the UV lamp(s) in the reactor, said lamp(s) is (are) preferably placed inside a protective casing consisting of a UV-transparent material, for example quartz, so as to protect the UV lamp from the production water.

In one particular embodiment, the irradiation is carried out intermittently, with irradiation/interruption cycles of which the duration is preferably between 10 minutes and 4 hours, the cycle durations being adjusted according to the production water, in particular according to the type and concentration of pollutants to be treated. The intermittent irradiation can advantageously make it possible to optimize the zeolite regeneration.

After it has been irradiated, the production water is separated from the zeolites by virtue of a separating means.

Said separating means may consist of any device known to those skilled in the art which makes it possible to obtain separation of the production water and of the zeolites. This separating means may advantageously be chosen from a filtration membrane, a cyclone and a decanter. Preferably, the separating means is a filtration membrane made of porous ceramic.

The means for separating the production water from the zeolites can be placed in the reactor or outside the reactor.

According to a first embodiment, the means for separating the production water from the zeolites is placed in the reactor. This embodiment advantageously makes it possible to reduce the bulk of the device for removing pollution. However, the separating means must in this case withstand the action of the ozone and of the UV radiation inside the reactor. The separating means may be a ceramic membrane.

According to a second embodiment, the means for separating the production water from the zeolites is placed outside the reactor. This embodiment is advantageous since it makes it possible to facilitate maintenance operations. The separating means is, for example, a hydrocyclone. According to this embodiment, a stream containing the production water and zeolites is removed from the reactor and is taken to said separating means. This stream is then separated into two parts: a part containing the zeolite-free production water for which pollution has been removed, and a second part containing the production water from which pollution has been removed, with the zeolites. Advantageously, the second part containing the production water from which pollution has been removed, with the zeolites, is reintroduced into the reactor. Thus, the weight of zeolites in the reactor does not vary.

The process which is the object of the invention advantageously makes it possible to recover production water from which pollution has been removed. Preferably, the production water from which pollution has been removed which is obtained contains:
less than 100 μg/l (micrograms per liter), preferably less than 10 μg/l, of polycyclic aromatic hydrocarbons, and/or
less than 10 μg/l (micrograms per liter), preferably less than 5 μg/l, of BTEXs, and/or
less than 100 μg/l (micrograms per liter), preferably less than 10 μg/l, of phenolic compounds, and/or
less than 100 μg/l (micrograms per liter), preferably less than 10 μg/l, of naphthenic acids, and/or
less than 100 μg/l (micrograms per liter), preferably less than 10 μg/l, of acetic acid.

Without, however, wishing to be bound by any theory, the inventors think that the process according to the present invention is particularly advantageous because there is a synergistic effect between the zeolites, the ozone and the UV light.

The ozone is known to be a powerful oxidizing agent and ozonation is a known technique for the oxidation of organic matter. It is thought that organic matter oxidation with ozone takes place according to two mechanisms: a direct action and an indirect action. The direct action describes the molecular ozone oxidation action. The indirect action is characterized by a first step of decomposition of ozone into free-radical species, in particular into hydroxyl radicals, followed by the action of these free-radical species on organic compounds.

Furthermore, UV radiation is used for removing pollution from water. Indeed, UV light has a bactericidal power owing to the deactivation or denaturation of the DNA of the microorganisms by the radiation emitted. Moreover, UV irradiation acts as a catalyst for the production of hydroxyl radicals from ozone.

Finally, zeolites are porous materials known for their adsorption properties. Zeolites of hydrophobic type are conventionally used to adsorb polluting organic compounds in water to be treated. Once separated, the zeolites must be treated in order to remove the adsorbed compounds and in order to be reused.

The inventors have noted that the simultaneous use of ozone, UV light and zeolites makes it possible to obtain, not an addition of the actions of each component, but a hybrid oxidation process with reinforced effectiveness.

Consequently, the combined use of ozone, UV light and zeolites makes it possible to reduce the ozone requirement compared with a process using only ozone. The means for producing ozone, for example ozone generators, can therefore be smaller in size, thereby enabling a saving in terms of space and a decrease in the costs of the apparatus. The decrease in the size of the equipment is particularly advantageous when the equipment is intended to be installed on a floating support.

In addition, while the hydrophobic zeolite seems to have the function of absorbing the polluting organic compounds, the inventors think that the hydrophilic zeolite performs a different technical function by acting as a catalyst for ozone decomposition.

The invention also relates to a device for removing pollution from production water which makes it possible to implement the process described above.

In particular, an object of the invention is a device for removing pollution from production water, comprising:
a reactor containing zeolites, having one or more inlet openings for introducing said production water and ozone, and at least one outlet opening;
one or more UV light source(s) arranged so as to irradiate the production water in the reactor;
a means for separating the production water from the zeolites, enabling the recovery of zeolite-free production water from which pollution has been removed.

This device may have the technical characteristics described above for the process.

Thus, the reactor can take the form of a column arranged vertically or horizontally, preferably vertically.

According to one embodiment, the reactor has at least a first inlet opening for introducing production water and at least a second inlet opening for introducing ozone. The first opening may be located on the lower part of the reactor. This first opening may consist of a single injection point or of a multitude of injection points. The second opening may also be located on the lower part of the reactor. This second opening may consist of a single injection point or of a multitude of injection points.

According to another embodiment, the reactor has an inlet opening for introducing a production water/ozone mixture. This opening may be located on the lower part of the reactor and may consist of a single injection point or of a multitude of injection points.

The reactor contains zeolites. The zeolites present in the reactor are chosen from the group consisting of hydrophilic zeolites, hydrophobic zeolites and a mixture of hydrophilic zeolites and hydrophobic zeolites.

The outlet opening of the reactor may be located on the upper part of said reactor. One or more other openings may also be made in the reactor, for example for the release of gas.

The UV light source is preferably one or more UV lamps. The UV lamp may be arranged in any way in the reactor, insofar as the UV light produced irradiates the production water in the reactor. Preferably, the UV lamp is arranged such that a maximum surface area of production water is irradiated. According to one embodiment, the reactor is column-shaped and the UV lamp is a single cylindrically shaped lamp, and said lamp is placed at the center of the reactor. According to another embodiment, several UV lamps are placed in several places inside the reactor. Whatever the arrangement of the UV lamp(s) in the reactor, said lamp(s) is (are) preferably placed inside a protective casing consisting of a UV-transparent material, for example quartz, so as to protect the UV lamp from the production water.

Said separating means may be chosen as described above, in particular from a filtration membrane, a cyclone and a decanter. Preferably, the separating means is a filtration membrane made of porous ceramic.

This separating means may be located in the reactor. It may, for example, form a wall in the reactor, allowing the production water to pass after it has been irradiated, but not the zeolites. The wall may define two compartments in the reactor: a reaction compartment in which the production water, in contact with the zeolites, is irradiated, and an outlet compartment which contains the zeolite-free production water after treatment. The zeolites are thus kept in the reactor, in the reaction compartment, and the production water from which pollution has been removed can be recovered at the reactor outlet, in the outlet compartment.

This separating means may also be located outside the reactor. In this case, the separating means may have an inlet opening in communication with the outlet of the reactor, a first outlet opening for the production water and a second outlet opening for the zeolites. Said second outlet opening of the separating means is in fluid communication with the reactor. This fluidic communication may be established directly in the reactor. Alternatively, the fluidic communication may be established with a pipe which itself communicates with the reactor. Preferably, said second outlet opening of the separating means is in fluidic communication with a pipe connected to at least one inlet opening of the reactor.

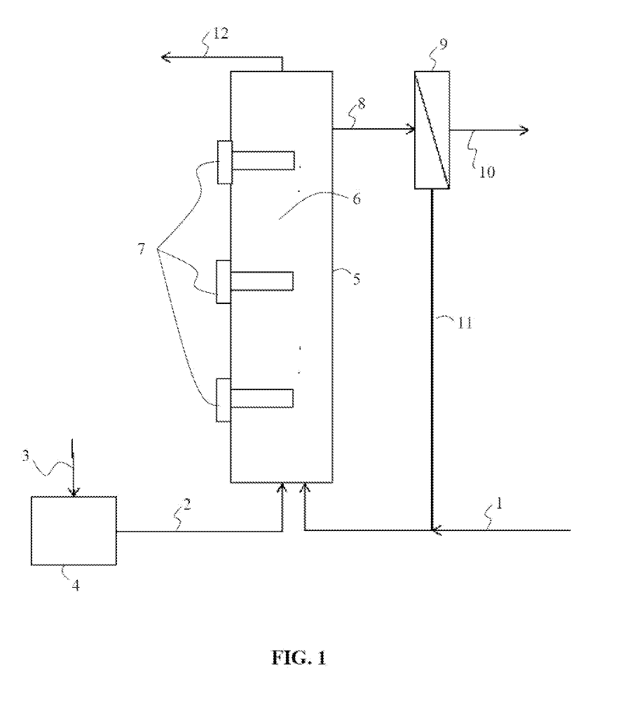

One advantageous embodiment of the process and of the device for removing pollution according to the invention is represented in [[f]] FIG. 1.

A stream of production water 1 and a stream of ozone 2 are introduced into a reactor 5 according to the invention. The stream of ozone 2 is produced by an ozone generator 4 from a stream of oxygen 3. Zeolites 6 in suspension are present in the reactor 5. UV lamps 7 are placed at several places in the reactor 5, and enable the irradiation of the production water in the reactor 5. After irradiation, the production water leaves the reactor 5 via the pipe 8. This water, which contains zeolites in suspension, is conveyed to a separating means 9. This separating means 9 makes it possible to recover, on the one hand, a stream 10 of zeolite-free production water from which pollution has been removed, and, on the other hand, a stream 11 of production water with the zeolites. This stream 11 is connected to the stream of production water 1, so as to be reintroduced into the reactor 5. The reactor 5 is also equipped with a gas outlet 12.

### EXAMPLES

The following examples illustrate the invention without, however, limiting the scope thereof.

The tests were carried out on a pilot ozonation device.

The ozonation pilot was composed of a glass reactor with a jacket in order to control the temperature of the effluent. A BMT 803N ozone generator makes it possible to generate ozone by electrical discharge in pure oxygen. The gas obtained (mixture of O₃ and O₂) was then directed to a frit placed at the bottom of a column constituting the reactor.

The gas recovered at the top of the column was passed through a phase separator in order to retain the overflow of liquid that may be entrained, and then entered a BMT 964 BT analyzer indicating the ozone concentration in the gas at the outlet.

A quartz casing, in which a 35 W low-pressure UV-C lamp generating a wavelength of 254 nm was placed, was inserted into the reactor.

The effluent was introduced into the reactor and then circulated in a recirculation loop and a 500 ml Erlenmeyer flask making it possible to increase the reaction volume (equipped with a rotary magnetic stirrer and placed on a heating block so as not to drop in temperature). One of two cells placed in the recirculation loop had a temperature probe, the other had a pH probe. A Masterflex peristaltic pump provides circulation of the liquid, pumped to the top of the column and reinjected at the bottom of said column. The total reaction volume was 1.2 l.

7.2 g of zeolites were introduced into the reactor. The zeolites were chosen from those described in table 1 below.

TABLE 1

| Compound | Zeolites 1 | Zeolites 2 |
|---|---|---|
| Commercial name | Purmol ®4ST | ZEOflair ®100 |
| Company | Zeochem | Zeochem |
| Hydrophilic/hydrophobic | hydrophilic | hydrophobic |
| nature | | |
| Grain size (μm) | 2->30 | 4 |
| Pore diameter (Å) | 4 | 5.6 |
| Specific surface area (m²/g) | | 400 |
| SiO₂/Al₂O₃ ratio | <10 | 400 |

The TOC (Total Organic Carbon) was carried out using a Shimadzu TOC-meter. The TOC is an overall indicator of the pollution since it represents the concentration of organic carbon in the water (in mg/l).

The COD (Chemical Oxygen Demand) represents the equivalent amount of oxygen for oxidizing the molecules present in the water and is measured using a Hach Lange heating block and DR 2800 spectrophotometer.

### Example 1

### Compared Study of TOC Degradation by Various Processes for Advanced Oxidation

A synthetic effluent was prepared so as to simulate production water.

TABLE 2

| | | | Boiling | Concen- |
|---|---|---|---|---|
| | | Molar mass | point | tration |
| | Formula | (g/mol) | (° C.) | (mg/l) |
| phenol | C₆H₆O | 94 | 182 | 200 |
| naphthenic | mixture of various | | 132 | 25 |
| acids | compounds | | | |
| acetic acid | CH₃COOH | 60.05 | 117.87 | 200 |
| pyrene | C₁₆H₁₀ | 202 | 404 | 0.05 |
| naphthalene | C₁₀H₈ | 128 | 217.7 | 0.95 |

This synthetic effluent was introduced into the pilot device described above and was subjected to various treatments:
ozone treatment only,
UV treatment only,
combined UV/zeolites 1 treatment,
combined ozone/zeolites 1 treatment,
combined ozone/UV/zeolites 1 and ozone/UV/zeolites 2 treatment.

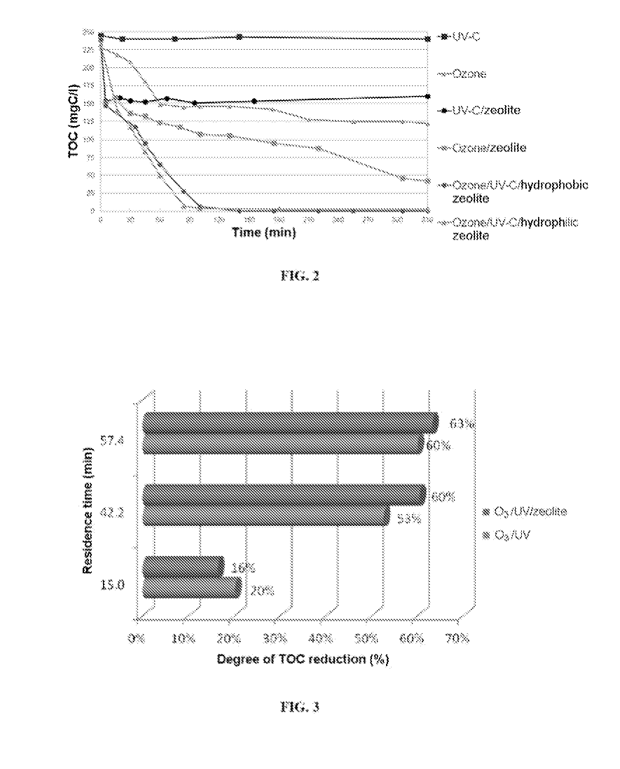

The change in the TOC was monitored over time for these various treatments and is represented in FIG. 2.

It can be noted that the combined use of UV, ozone and zeolites makes it possible to obtain high oxidation kinetics.

### Example 2

### Study of the Influence of the Zeolite Type

In the pilot device described above, the synthetic effluent described in table 2 was subjected to:
a combined treatment A: ozone/UV/zeolites 1
a combined treatment B: ozone/UV/zeolites 2.

The water temperature was maintained at 35° C.

These tests made it possible to measure the following parameters, represented in table 3:
the first-order degradation kinetics constant (in s⁻¹).
the linear regression coefficient for this modeling,
the weight ratio of the TOC reduced to the ozone consumed, and
the reduction of the TOC at the end of handling.

TABLE 3

| | k TOC (s⁻¹) | r² TOC | g C_{organic} | |
|---|---|---|---|---|
| | (1^{st} order | (1^{st} order | reduced/g | Reduction |
| | modeling) | modeling) | O₃ consumed | TOC (%) |
| A | 4.12 × 10⁻⁴ | 0.9473 | 2.1 | >97 |
| B | 5.80 × 10⁻⁴ | 0.9618 | 2.1 | >98 |

It could be noted that the final reduction in TOC is greater than 95%, which proves the effectiveness of the treatments A and B.

### Example 3

### Treatment of Various Production Waters

The synthetic effluent described in table 2 and two production waters originating from various oil production sites were subjected to a combined ozone/UV/zeolites 1 treatment in the pilot device described above. The water temperature was maintained at 35° C.

The production waters had the characteristics given in table 4 below:

TABLE 4

| | TOC (mg/l) | COD (mg O₂/l) | [NaCl] (g/l) | pH |
|---|---|---|---|---|
| Production water 1 | 158 | 910 | 8 | 6.9 |
| Production water 2 | 196 | 688 | 80 | 6.9 |

Production water 2 initially exhibited a significant turbidity. Production water 2 was therefore subjected to a preliminary treatment: either a 5-fold dilution, or a centrifugation.

These tests made it possible to measure the following parameters, represented in table 5:
the first-order degradation kinetics constant (in s⁻¹),
the linear regression coefficient for this modeling,
the weight ratio of the TOC reduced to the ozone consumed, and
the reduction in TOC at the end of handling.

TABLE 5

| | k TOC (s⁻¹) | r² TOC | g C_{organic} | |
|---|---|---|---|---|
| | (1^{st}-order | (1^{st}-order | reduced/g | Reduction of |
| | modeling) | modeling) | O₃ consumed | TOC (%) |
| Synthetic | 4.9 × 10⁻⁴ | 0.9641 | 2.48 | >98 |
| matrix | | | | |
| Prod. Water 1 | 3.2 × 10⁻⁴ | 0.8337 | 0.88 | 98.5 |
| Prod. water 2 | 2.5 × 10⁻⁴ | 0.8950 | 0.60 | 96.0 |
| diluted 5 times | | | | |
| Prod. water 2 | 2.4 × 10⁻⁴ | 0.8294 | 3.04 | 98.6 |
| centrifuged | | | | |

It could be noted that the final reduction in TOC is greater than 95%, which proves the effectiveness of the process not only on a synthetic effluent, but also on actual production waters. The process for removing pollution therefore makes it possible to treat, nonspecifically, organic polluting compounds of any type, whatever the type of molecules.

### Example 4

### Continuous Treatment

The synthetic effluent (table 2) was treated continuously on a pilot unit. It was subjected to various treatments:
combined UV/ozone treatment, and
combined UV/ozone/zeolites 1 treatment.

The reductions in the TOC were measured after stabilization of the unit for various residence times in the reactor, and are represented in [[f]] FIG. 3.

The results indicate an improvement in performance levels with the combined UV/ozone/zeolites process compared with the UV/ozone process, in particular for a residence time of 42.2 min.

The embodiments above are intended to be illustrative and not limiting. Additional embodiments may be within the claims. Although the present invention has been described with reference to particular embodiments, workers skilled in the art will recognize that changes may be made in form and detail without departing from the spirit and scope of the invention.

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

1. A process for removing pollution from production water, comprising the following steps:
introducing said production water and ozone into a reactor containing zeolites,
subjecting the production water in the reactor to irradiation by UV light, and
separating the production water from the zeolites by virtue of a separating means, so as to obtain production water from which pollution has been removed.

2. The process according to claim 1, wherein the production water contains polluting compounds that include:
at least 0.1 mg/l of polycyclic aromatic hydrocarbons, and/or
at least 0.5 mg/l of BTEXs, and/or
at least 0.5 mg/l of phenolic compounds, and/or
at least 0.1 mg/l of naphthenic acids, and/or
at least 0.1 mg/l of acetic acid.

3. The process according to claim 1, wherein the zeolites are hydrophilic zeolites.

4. The process according to claim 1, wherein the zeolites are hydrophobic zeolites.

5. The process according to claim 1, wherein the zeolites are a mixture of hydrophilic zeolites and hydrophobic zeolites.

6. The process according to claim 1, wherein the means for separating the production water from the zeolites is a filtration membrane made of porous ceramic.

7. The process according to claim 1, wherein the means for separating the production water from the zeolites is placed outside the reactor.

8. The process according to claim 1, wherein the means for separating the production water from the zeolites is placed in the reactor.

9. The process according to claim 1, further comprising a preliminary step consisting in removing the suspended matter in the production water before introducing the production water into the reactor.

10. A device for removing pollution from production water, comprising:
a reactor containing zeolites, having one or more inlet openings for introducing said production water and ozone, and at least one outlet opening;
one or more UV light source(s) arranged so as to irradiate the production water in the reactor;
a means for separating the production water from the zeolites, and enabling the recovery of zeolite-free production water from which pollution has been removed.
